(19) United States
(12) Patent Application Publication
(10) Pub. No.: US 2007/0015120 A1
(43) Pub. Date: Jan. 18, 2007

(54) Travel recording apparatus

(76) Inventor: Jeffrey N. Ide, Riley, MI (US)

Correspondence Address: J. Gordon Lewis, 441 North Evansdale Drive, Bloomfield Hills, MI, 48304, US

(21) Appl. No.: 11/181,104

(22) Filed: Jul. 14, 2005

(51) Int. Cl. G09B 29/00

(52) U.S. Cl. 434/150

(57) ABSTRACT

An apparatus for recording theme-based travel related events includes a set of display pieces, each configured to depict a scaled, specific geographic area and, when arranged in a predetermined orientation, collectively depict a larger, substantially contiguous geographic region. A display tray forms a flat display surface dimensioned to hold the entire set, or selective subsets of display pieces. A storage tray holds the unused display pieces. Magnets, adhesive and/or mechanical interlocks retain the individual display pieces on either the display or storage tray. A mounting frame holds the display tray for wall mounted viewing of the changing mosaic of display pieces and simultaneously stores the unused pieces. A partially pre-formatted travel ledger carried with the frame records key dates, locations and events.

### TECHNICAL FIELD

The present invention relates to methods and systems for facilitating the recordation, preservation and visual display of topical information. More particularly, the present invention relates to apparatus for systematically organizing and displaying accumulated information relating to a particular subject in a simplified, vision based format. More particularly still, the present invention relates to the mounting and decorative display on vertical wall surfaces of map elements especially suited for teaching theme based geography.

### BACKGROUND OF THE INVENTION

Geography is an interesting and unifying subject that describes our world. As we watch or read the news, we organize the information we assimilate in many ways. One category always exists—location. Everything happens somewhere. Geography is the subject that relates what we learn to where we are, and provides a frame of reference for learning about subjects such as history, politics, geology, culture or religion.

The study of geography requires a large amount of information to be conveyed to and absorbed by students. Current surveys indicate that the average student in the United States does not have a strong grasp on the geography of even the locality in which he resides, let alone the country as a whole or the world. One reason is that the typical teaching tools bombard students with information. The most common display devices used in teaching geography are maps, globes or drawings of individual geographic regions such as states in the Union. While maps and the like convey accurate information, they present it in such a mass format that it is difficult for students to absorb, particularly with respect to the relationship of different geographic areas and the location of cities, rivers or topographical features within those areas. Moreover, maps and the like are not interactive with the students and require considerable concentration and memory power rather than an easy association of places and things with easily identifiable physical objects.

In addition to being a tool for formal education, geography based games and activities are widely popular. For example, during lengthy family excursions, games and puzzles related to geographical or topographical features are often employed to amuse and entertain children as well as to provide an educational reinforcement of highlights of the trip. A disadvantage of such games and activities is that they are not well adapted to generate a permanent record or allow distillation and organization of accumulated information for later use for presentation and display.

Maps and geographic aids are typically focused upon depicting general political information, i.e. man-made features such as cities, roads, state and national boundaries and the like. Topographical maps alternatively depict naturally occurring features such as rivers, lakes, mountain ranges, forests and the like. Both types of standard maps suffer from the same shortcoming when they are used for identifying or recording specific information relating to non-standard topics. They tend to be replete with non-useful information that clutters the map and obfuscates the valuable information. Furthermore, standard maps generally do not readily accommodate modification or the entry of additional supplemental information or the display thereof in an attractive format.

U.S. Pat. No. 4,937,181 to Rogers relates to a visual display system for teaching geography in which three dimensional objects formed to be representative of geographical regions, such as individual states and the like, may be detachably affixed to a suitable background and arranged to demonstrate the relationship between the objects. A second set of objects representing geographical features such as the name of states or cities, or topographical features such as mountains, lakes or rivers, are also provided, this second set of objects being detachably affixed to the first objects so that a three dimensional display of a geographical area complete with names and topography can be assembled and displayed.

U.S. Pat. No. 5,259,763 to Wendel et al. describes silk-screened United States, world, regional or individual continent, country and state maps on a looped backed material, which illustrate the outline of the states, countries, as well as the location of pertinent rivers, water bodies and major cities/capitals. The locations are not labeled on the map, but instead, location names are located on a small tab. At least one small square of hook material attaches to the backside of the tab, and can be correctly placed on the map at predetermined points and easily removed from the map for further usage. The hooks on the tab engage into the hooks on the map. Other activities can be utilized, such as numbers, spellings, or other educational activities with hooked tabs engaging onto the loop material.

U.S. Pat. No. 5,800,182 to Carson et al. describes an interactive teaching aid including a fabric or plastic panel having a binding attached around the outer edges of the structure for providing structural integrity, a plurality of hangers for permitting the panel to be hung on a wall or stand, and panel indicia on at least one surface of the panel. The teaching aid also includes removable relational manipulative elements for attaching to the panel, the relational manipulative elements including element indicia related to the panel indicia.

U.S. Pat. No. 5,158,295 to Shilling relates to puzzles in which multiple linear pieces, each presenting a portion of a picture, are adapted to be interfitted to form a sheet presenting the picture. Such puzzles are commonly referred to as “jigsaw” puzzles. Shilling describes a standard jigsaw puzzle with a magnetic back whereby the pieces of the puzzle will adhere by magnetic attraction to a ferrous backing plate. This plate may be provided with a picture frame. Trim strips with magnetic backing may be used to fill any space existing between the border of the assembled puzzle and the picture frame. The magnetic backing on the puzzle is applied as a back layer before the puzzle is divided into multiple pieces during manufacture.

What remains needed in the art, is an apparatus for conveniently recording the highlights of past trips or visits to particular geographic areas such as the states of the Union in such a manner that the cumulative travel experiences of a particular individual, family or group can be logged and presented visually in a clear, understandable and aesthetically pleasing manner. Moreover, the apparatus preferably should be theme-based, i.e. focused on a particular type of activity, such as camping trips to national parks, visits to the capitals of the various states, cross-country motorcycle tours and the like, that are of common interest.

### BRIEF DESCRIPTION OF THE INVENTION

Generally, the present invention fulfills the forgoing needs of the known prior art by providing a travel recording apparatus including a set of display pieces, wherein each display piece is configured to depict a specific geographic area, such as a state, province or the like, and, when arranged in a predetermined orientation, collectively configured to depict a larger geographic region, such as a country, continent or hemisphere. A display tray defining a generally planar display surface is dimensioned to circumscribe the entire set of display pieces when arranged to form the geographic region. A storage tray defines one or more generally planar storage surfaces dimensioned to circumscribe the entire set of display pieces when arranged thereon. A frame serves to retain the display and storage trays in spaced juxtaposition wherein the display surface and any pieces disposed thereon are outwardly visible, and the storage surface, and any pieces disposed thereon are substantially obscured from view for esthetic purposes. Finally, retention means selectively affix some or all of the display pieces at corresponding predetermined locations on the display surface and, alternately, on the storage surface. This arrangement has the advantage of a compact and attractive design suitable for open or public display.

According to an aspect of the preferred embodiment of the invention, permanent magnets are affixed to each display piece for selective affixation to the display tray, which is formed, at least in part of ferrous material. This arrangement has the advantage of permitting re-use and re-positioning of the individual display pieces without degradation in function.

Alternatively, “peal and stick” arrangements employing an adhesive layer covered by a removable protective cover can be substituted for permanent magnets. Although usable for only a limited number of times, the alternate adhesive approach avoids the requirement of ferrous materials in the trays and can result in a flatter, more compact overall package.

Furthermore, a system of mechanical interlocks can be employed as a second alternative to the above species of fastener means. Although more structurally complex, mechanical interlock systems can further reduce cost and result in a more robust assembly, wherein the function of which will not degrade over extended periods of time. This is particularly important when the travel recording apparatus is being displayed vertically and/or is subjected to vibration such as when displayed in a travel trailer or motor coach.

According to another aspect of the preferred embodiment of the invention, the display tray and storage tray are conjoined to comprise a single structure comprising a rigid, generally planar base member having a first surface defining said display surface and an opposed second surface defining said storage surface. This arrangement further reduces cost and overall packaging size of the travel recording apparatus.

According to another aspect of the invention, a scaled outline map of the geographic region, as well as geographic area subdivision is imprinted, such as by silk-screen process directly upon the display surface of the display tray. Thus, each display piece has its own corresponding outline map on the display tray with a substantially 1:1 scale to guide the placement and orientation of the display piece on the display surface. This arrangement has the advantage of depicting the entire geographic region as well as clearly delineates the boundaries of and between the individual geographic areas, even when some or all of the display pieces are absent. As such, more information is efficiently visually conveyed, i.e. what geographic areas have previously been visited and what geographic areas remain to be visited.

According to another aspect of the invention, the outline map can be replicated on the storage surface area of the storage tray, illustrating a convenient location to store display pieces, which are not yet ready for display. If the trays are symmetrically configured, their roles can be reversed, with the display tray serving as the storage tray and vice versa. This arrangement provides additional functionality and flexibility in the use and application of the travel recording apparatus.

According to another aspect of the invention, the map outline traces are raised from the display surface and function to embrace the peripheral edge of an associated display piece to assist in its proper orientation and retention. The raised traces can be complete, fully circumscribing each associated display piece or partial, to ensure proper placement. The raised traces also function to create precise gaps or inter-spacing between adjacent display pieces. This arrangement has the advantage of improving overall esthetic appeal, as well as permits usage of complimentary or contrasting color schemes (between the display pieces and the outline map as well as the overall tray display area).

According to an alternative embodiment of the invention, an optically clear (plastic or glass) closure member is affixed to the mounting frame to overlay the display tray as well as any display pieces disposed thereon. This feature serves to keep foreign objects and air borne contaminates away from the travel recording apparatus, thereby enhancing overall appearance. Furthermore, when the inner surface of the closure member is closely spaced from the viewable surface of the pieces on the display tray, they can co-act to mechanically interlock the display pieces in place, resulting in a more robust overall design.

According to another aspect of the preferred embodiment of the invention, a travel event ledger is carried by and at least partially stored within said mounting frame. The travel event ledger is imprinted upon a generally planar rigid base member, such as foam board, and contains pre-formatted data or information fields. Information fields are provided for each geographic area or subset. In some instances, some information fields are pre-filled with data (during assembly or prior to the application of the travel recording apparatus). Anticipated fields are: geographic region, date (of first visit), event attended or location visited and comments. Pre-filled data, such as an alphabetical listing of all geographic areas (ex. states of the United States) will ensure a complete record of past visits to points of interest as well as a listing of future visit locations is created. The travel ledger also provides a mechanical function inasmuch as it is slidably disposed within the mounting frame near the back portion of the travel recording apparatus, assisting in maintaining a substantially closed structure. When employed together, the front closure member and travel event ledger fully enclose the travel recording apparatus to ensure against loss loose display pieces.

According to still another aspect of the invention, marker means are provided for selective affixation to a given display piece to identify a precise location visited within the associated actual geographic area. Preferably, the marker means comprises an elongated pin inserted from the backside of the associated display piece and emerges to be substantially flush with the front surface of the display piece. The pin has a bright or contrasting color vis-à-vis the viewable face of the display piece. A thin, translucent overlayment, such as Mylar, permits viewing of only the end of the pin while maintaining an esthetically pleasing overall appearance. This feature has the advantage of permitting application and re-application of marker pins within display pieces without degrading the appearance of the display piece. That is, when removed, a marker pin will leave no tell-tale hole or opening.

According to yet another aspect of an alternative embodiment of the present invention, the display pieces and storage tray can be simultaneously co-formed from a single rigid sheet of planer base material such as foam core board. That is, the foam board can be die punched to define the periphery of each display piece. When in storage, the individual die cut display pieces remain in their original position within a pocket in the storage tray. When required for display purposes, an individual display piece can be simply dressed out of the storage tray and applied upon the display tray. If desired, a display piece can be reinserted within its associated pocket within the storage tray.

These and other features and advantages of this invention will become apparent upon reading the following specification, which, along with the drawings, describes preferred and alternative embodiments of the invention in detail.

### BRIEF DESCRIPTION OF THE DRAWINGS

The present invention will now be described, by way of example, with reference to the accompanying drawings, in which:

FIG. 1, is a front plan view of the travel recording apparatus of the present invention;

FIG. 2, is a cross-sectional view of the travel recording apparatus taken on line 2-2 of FIG. 1;

FIG. 3, is a cross-sectional view of the travel recording apparatus taken on line 3-3 of FIG. 1;

FIG. 4, is a broken view of a portion of the cross-sectional view of FIG. 2, on an enlarged scale;

FIG. 5, is a broken view of another portion of the cross-sectional view of FIG. 2, on an enlarged scale;

FIG. 6, is a broken, perspective view of a portion of a piece storage tray from the embodiment of the travel recording apparatus of FIGS. 1-5;

FIG. 7, is a broken, cross-sectional view of a portion of a display tray from an alternative embodiment of the invention with a display piece installed;

FIG. 8, is a broken, cross-sectional view of a portion of a third alternative embodiment of the invention with the display and storage trays conjoined;

FIG. 9, is a location marker employed with display pieces of the travel recording apparatus of the present invention;

FIG. 10, is a front plan view of a display piece for application with the travel recording apparatus of the present invention with a location marker of FIG. 9 installed;

FIG. 11, is a broken, cross-sectional view taken along lines 11-11 of FIG. 10, on an enlarged scale, illustrating the installation of the location marker of FIG. 9 and the removal of underlying adhesive covering material;

FIG. 12, is a cross-sectional view of a forth alternative embodiment of the travel recording apparatus of the present invention;

FIG. 13, is the obverse data entry side of a travel event recording ledger from the travel recording apparatus of FIG. 12; and

FIG. 14, is the reverse map reference side of the travel event recording ledger of FIG. 13 for use with the travel recording apparatus of FIG. 12.

### DETAILED DESCRIPTION OF THE PREFERRED AND ALTERNATIVE EMBODIMENTS OF THE INVENTION

The present invention is intended for application in recording, assimilating and displaying aggregate travel related information pertaining to specific events and localities relating to motorcycle touring in the United States of America and will be described in that context. It is to be understood, however, that the present invention would be of equal value in many other theme-based travel activities. Accordingly, the claims herein should not be deemed as limited to the specifics of the preferred and alternative applications as described hereunder.

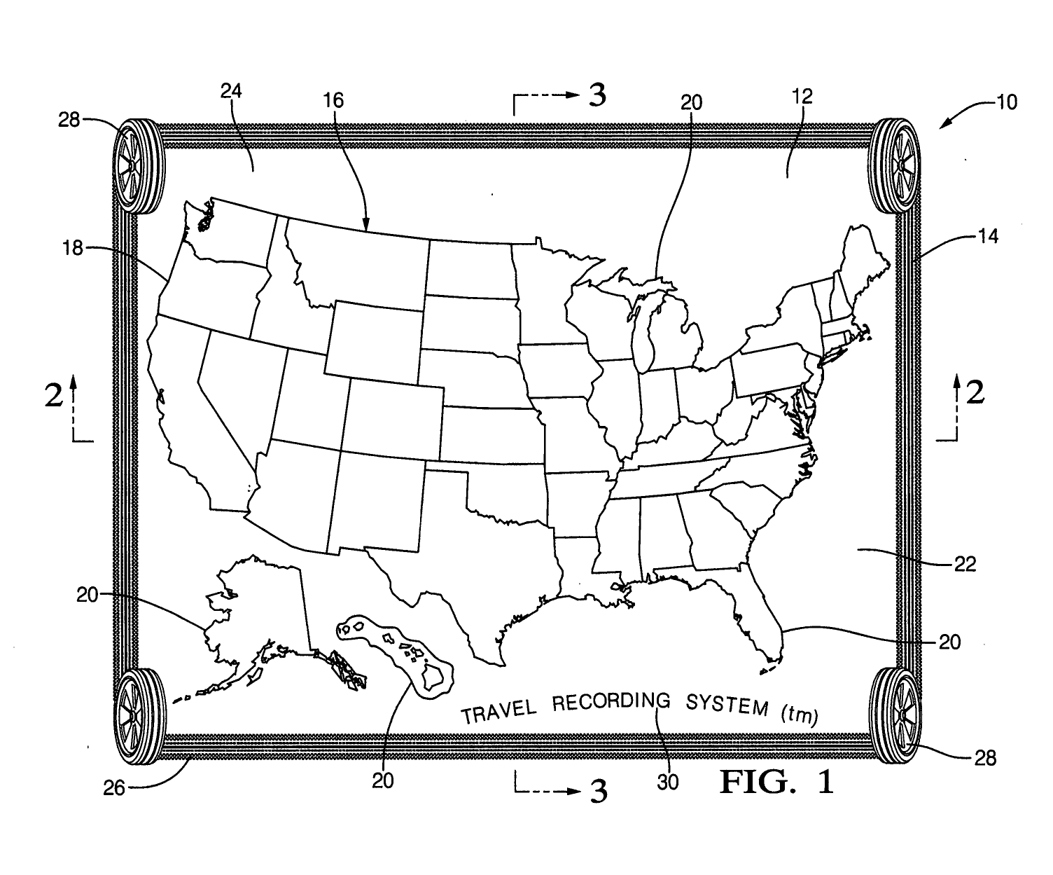

Referring to FIG. 1, a travel recording apparatus 10 is illustrated as it would be normally viewed in application. Travel display apparatus 10 is configured to have the overall appearance of a wall hanging, including an object for display 12 circumscribed by a decorative, generally rectangular frame assembly 14.

The display object 12 is designed to depict a predetermined, substantially contiguous geographic region 16 in the form of an outline map 18 and environs. In the illustrated embodiment, the outline map 18 depicts the fifty states comprising the United States of America. For definitional purposes, the states of Hawaii and Alaska are deemed to be “substantially contiguous” with the remaining 48 states.

Outline map 18 is effectively an assemblage of separate outline maps of each of the fifty individual specific geographic areas 20 or states juxtaposed to correspond with the actual topographical positioning (with the exception of Hawaii and Alaska) of the states themselves. Outline map is silk-screen printed upon an outwardly facing surface or display surface 22 of a display tray 24 mounted within frame assembly 14 about the periphery thereof. Display surface 22 is preferably a single color (ex. white) and the lines forming the outline map 18 are a contrasting single color (ex. black).

The forwardmost face 26 (facing the viewer) of frame assembly 14 has theme-specific ornamentation 28 thereon designed to decoratively compliment the display object 12. The example illustrated in FIG. 1 is vehicle wheels and tires located at each corner of frame assembly 14 with interconnecting tire tread patterns. Furthermore, theme-based indicia 30 is included in the display object 12 suggestive of subject matter, commercial sponsorship, voluntary association, club affiliation or other theme-related supplemental information. The present invention can be used as a promotional aid for commercial sponsors such as motorcycle manufacturers, airlines, bus lines, railways, recreational vehicle (RV) manufacturers, campground proprietors, travel clubs and franchise businesses (ex. chain hotels & restaurants).

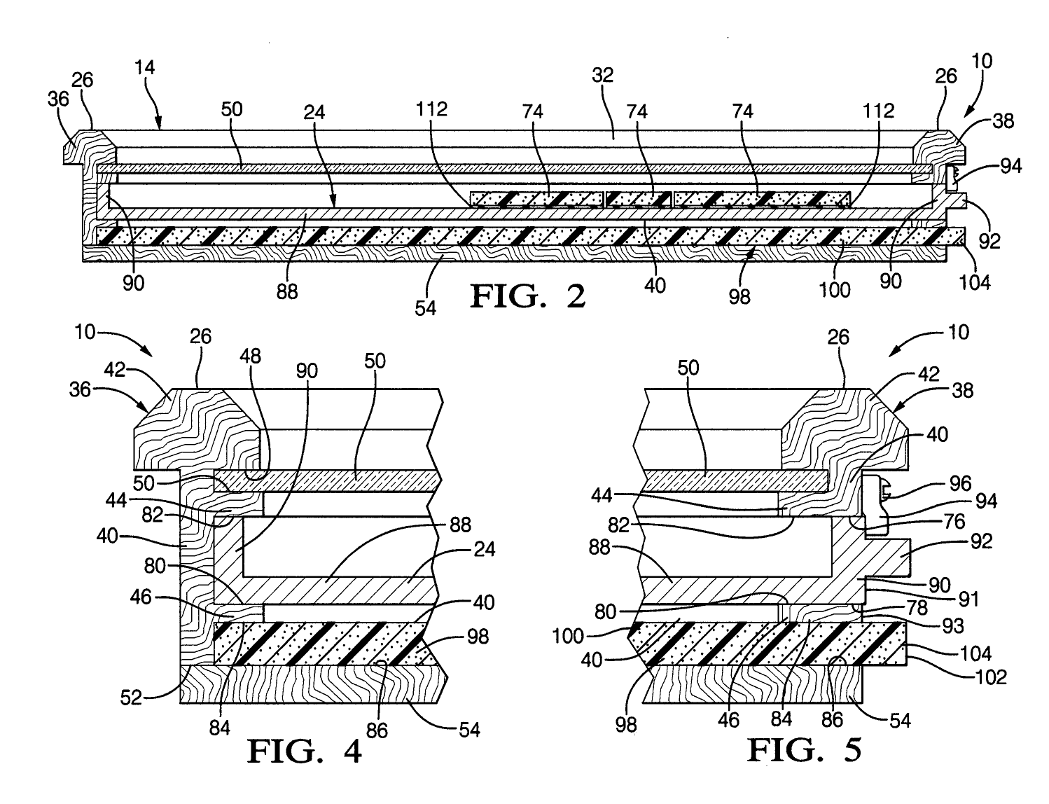

Referring to FIGS. 2-5, the structural details of a first embodiment of travel recording apparatus 10 are illustrated. Frame assembly 14 is composed of upper and lower elongated frame members 32 and 34, respectively, and left and right (from the perspective as viewed in FIG. 1) elongated side frame members 36 and 38, respectively, arranged and joined at the respective ends thereof in a generally rectangular configuration. Upper, lower and left frame members 32, 34 and 36, respectfully, have a substantially common cross-sectional area along their respective lines of elongation, including an elongated base portion 40 and an enlarged frontispiece 42. Frame assembly 14 is preferably formed of wood, but could alternately be constructed of plastic, metal or other suitable material capable of having a decorative finish and supporting the overall structure of the travel recording apparatus 10. Display tray 24 can be made from many varied materials. It is believed that sheet steel or tin works well with known photo-lithographic processes.

First and second flanges 44 and 46, respectively, are integrally formed with the base portion 40 of each frame member 32, 34, 36 and 38, and extend inwardly there from. As best viewed in FIG. 4, first flange 44 is spaced slightly below the frontispiece 42, whereby the lower surface 48 of frontispiece 42 faces the upper surface 50 of first flange 44 to entrap a closure member 50 there between. Closure member 50 is preferably constructed of transparent or translucent glass, but can alternatively be constructed of any suitable material.

The bottom edge surface 52 or each base portion 40 of frame members 32, 34, 36 and 38 are affixed to the peripheral edges of an opaque bottom member 54 which, in combination with upper closure member 50 substantially encloses the frame assembly 14 to secure loose pieces, as will be described herein below, and to seal the frame assembly 14 against entry of foreign objects or airborne contaminants. If desired, hermetic seals can be provided as well as ultraviolet light filtering coatings on the front closure member 50 to maximize protection from adverse outside influences, especially accumulation of dust and fading due to direct exposure to sunlight.

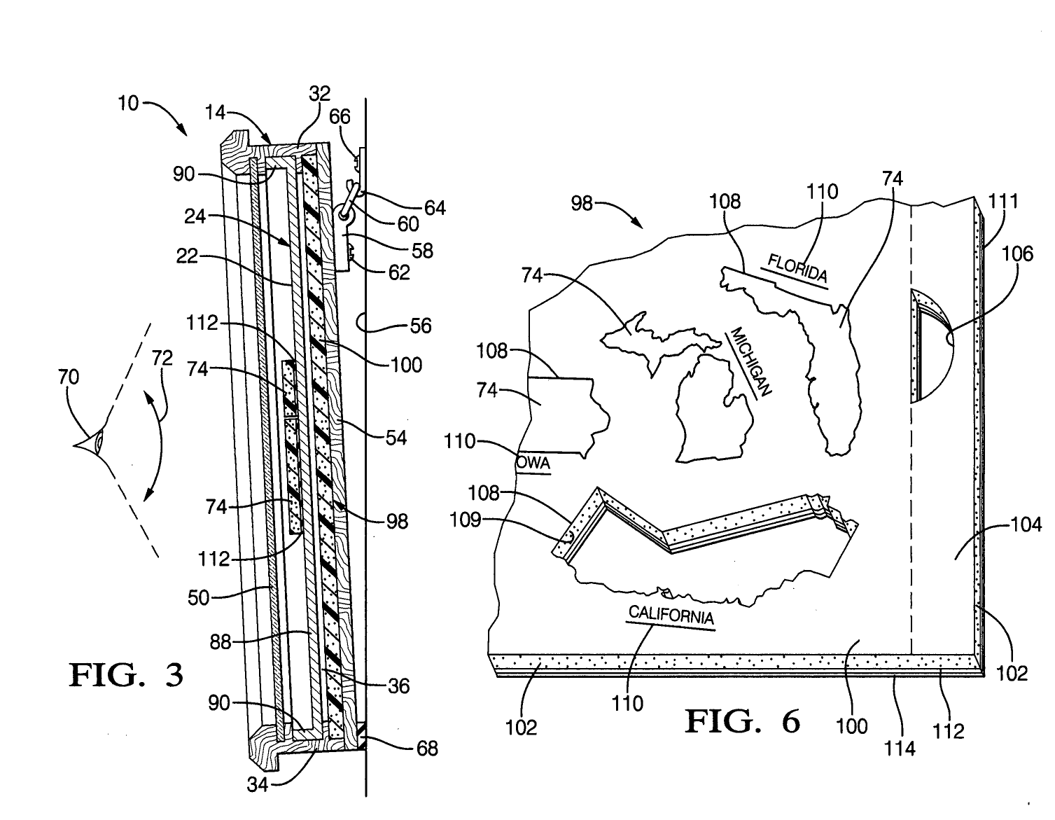

Referring to FIG. 3, the generally vertical mounting of travel recording apparatus 10 on a wall 56 is illustrated. A hanger 58, including a D-ring 60 pivotally affixed thereto is fastened to the rearward facing surface of bottom member 54 of frame assembly 14 by a screw 62 located adjacent upper frame member 32. An anti-scuff pad 68 is adhesively affixed to the back side of bottom member 54 located adjacent lower frame member 34 and is compressed against the wall 56 by the frame assembly 14. A J-hook 64 is affixed to wall 56 by a screw 66. Travel recording apparatus 10 is retained in its intended location by capturing the D-ring 60 over the J-hook 64. Two or more such wall fasteners can be employed if required by the weight, size or application of the travel recording apparatus 10. Furthermore, it is contemplated that the present invention may be employed in a mobile application such as a boat or over-the-road recreational vehicle. Accordingly, additional, multi-axis wall mounting means may be required to ensure robust retention of the travel recording apparatus 10 in all directions. One possibility would be direct, permanent attachment of the travel recording apparatus 10 to the wall 56 by fasteners such as screws or double-sided adhesive disposed between the rear surface of the bottom member 54 and the exposed surface of the wall 56.

A viewer 70 disposed in front of the wall mounted travel recording apparatus 10 will have a range of vision 72 which extends through the closure member 50 and includes substantially the entire display surface 22 of display tray 24 as well as any display pieces 74 disposed thereon.

Referring to FIG. 5, the right side frame member 38 of frame assembly 14 has first and second vertically elongated tray receiving slots 76 and 78, respectively, extending there through. First tray receiving slot 76 extends vertically (as viewed in FIG. 5) between the upper surface 80 of second flange 46 and the opposed lower surface 82 of first flange 44. Second tray receiving slot 78 extends vertically between the lower surface 84 of second flange 46 and the opposed inner (upper) surface of bottom member 54 of frame assembly 14. Tray receiving slots 76 and 78 extend laterally (into and out of the drawing sheet when viewing FIG. 5) substantially the entire width of right side frame member 38.

The display tray 24 comprises a rectangular bottom panel 88 and upstanding side panels 90 integrally formed with and extending entirely about the periphery of bottom panel 88, forming an open topped enclosure. Side panels 90 have a vertical dimension slightly greater than the nominal thickness of the display pieces 74 to ensure against inadvertent contact between the display pieces 74 and the frame assembly 14 as the display tray 24 is being opened or closed, thereby maintaining positional integrity of the display pieces 74 on the display surface 22 of the display tray 24. Display tray 24 is dimensioned to effect a precise slip fit within the generally rectangular cavity formed within frame assembly 14 vertically intermediate lower surface 82 of first flange 44 and upper surface 80 of second flange 46, laterally (generally up and down when viewing FIG. 3) intermediate the inwardly facing surfaces of the base portions 40 of upper and lower frame members 32 and 34, respectively, and longitudinally (left and right when viewing FIGS. 2, 4 and 5) intermediate the inwardly facing surfaces of the base portions 40 of left and right side frame members 36 and 38, respectively.

When fully installed within frame assembly 14, display tray 24 fully occupies its receiving cavity within frame assembly 14. As best viewed in FIG. 5, the outer (lefthandmost) surface 91 of side panel 90 of display tray 24 emerging from first tray receiving slot 76 is flush with the outer surface 93 of the base portion 40 of the right side frame member 38. A pull 92 integrally formed with side panel 90 extends outwardly there from to provide a handle for gripping and slidably opening display tray 24 from within frame assembly 14. A catch 94 is affixed upon the outer surface 93 of base portion 40 of right side frame member 38 adjacent first tray receiving slot 76 by a screw 96 or other suitable fastener. Catch 94 serves to selectively lock the display tray 24 in its illustrated closed position and can be manually repositioned to permit selective opening of the display tray 24 to gain access to display pieces 74 disposed on the display surface 22 thereof.

A storage tray 98 comprises a rectangular base portion 100 having a layered composite structure and edge surfaces 102 extending entirely about the periphery of the base portion 100. The specifics of the construction of the base portion 100 will be described herein below. Storage tray 98 is dimensioned to effect a precise slip fit within the generally rectangular cavity formed within the frame assembly 14 vertically (as viewed in FIG. 5) intermediate the inner surface 86 of the bottom member 54 and the lower surface 84 of the second flange 46, laterally intermediate the inwardly facing surfaces of the base portions 40 of upper and lower frame members 32 and 34, respectively, and longitudinally intermediate the inwardly facing surfaces of the base portions 40 of left and right side frame members 36 and 38, respectively.

When fully installed within frame assembly 14, storage tray 98 fully occupies its receiving cavity within frame assembly 14. As best viewed in FIG. 5, the outer edge surface 102 of storage tray 98 emerging from the second tray receiving slot 78 extends slightly outwardly beyond the outer surface 93 of the base portion 40 of the right side frame member 38 forming an integral pull 104 (refer FIG. 6). As in the case of the pull 92 for display tray 24, the pull 104 for storage tray 98 provides a handle for gripping and slidably opening storage tray 98 from within frame assembly 14. A catch (not illustrated) can be provided to selectively lock the storage tray 98 in its illustrated closed position.

Pulls 92 and 104, as well as catch 94 are located below the overhanging frontispiece 42 of the right side frame member 38 to obscure them from the viewer 70 (see FIG. 3).

A significant advantage of the overall design of the travel recording apparatus 10, and particularly the frame assembly 14 and trays 24 and 98, is that the trays 24 and 98 can be easily opened, removed and replaced to their respective stowed positions while the travel recording apparatus 10 is hanging on the wall 56 and on display. This feature maximizes the user's appreciation of the travel recording apparatus 10 by continuously updating the array of display pieces 74 on the display surface 26 of the display tray 24 on a virtually real time basis, such as, by way of example, during a cross-country trip when several states may be visited for the first time in a single day.

Referring to FIG. 6, a broken portion of the storage tray 98 is illustrated. In this embodiment of the invention, the storage tray 98 is co-formed with the display pieces 74 as a single, planer sheet of material within which each of the (50) display pieces is punched or die-cut from the base material. The edge surfaces 102 are likewise punched or die-cut to form the periphery of the storage tray 98 circumscribing all of the display pieces 74. A finger grip hole 106 is also formed in the pull 104 portion of the base portion 100 of the storage tray 98.

In FIG. 6, the illustrated display pieces 74 corresponding with the states of Iowa (partial), Florida and Michigan remain in their respective stored positions within storage tray 98. The display piece 74 corresponding with California has been removed for placement on the display tray 24. Peripheral outlines 108 on the upper surface of the storage tray 98 mimic the adjacent die-cut outline 109 of each display piece 74 to highlight the designated storage location of each display piece 74. Alpha-numeric descriptors 110 are also imprinted on the upper surface of the base portion 100 of the storage tray 98 to further clarify the proper storage location of each display piece 74. As will be discussed in greater detail herein below, a travel event ledger 111 can be imprinted upon or formed separately on sheet material and attached to storage tray 98.

In the embodiment of the invention depicted in FIGS. 1-6, affixation of display pieces is accomplished by the provision of an adhesive layer 112 on the underside of each display piece 74. Although a separate adhesive layer 112 can be separately applied to each of the fifty display pieces 74, the preferred approach is to fabricate the storage tray 98 from light weight rigid material such as foam board, which is a lamination of sheet foam material overlaid on both surfaces by high quality heavy gauge paper. Indicia 30, peripheral outlines 108, alpha-numeric descriptors 110 and travel event ledger 111 as well as background coloration and decoration can be imprinted on the upper (viewable) surface of the foam board. The adhesive layer 112 and an overlaying protective cover material 114 can be applied to the lower surface of the foam board. The adhesive layer 112 must be of a material with an affinity for the material forming the display surface 22 of the display tray 24, which is preferably plastic or metal.

In application where all of the display pieces 74 are co-formed with the base portion 100 of the storage tray 98, it would be convenient to apply the adhesive layer 112 and cover material 114 over the entire lower surface of the foam board. The entire laminated assembly should be die-cut most of the way through the material, leaving just enough interconnecting material to ensure that the unused display pieces 74 remaining in the storage tray 98 will remain in place while the storage tray 98 is periodically removed and re-installed through the second tray receiving slot 78 of the frame assembly 14.

When a particular display piece 74 is desired for affixing to and display with the display tray 24, the storage tray 98 would first be removed from the frame assembly 14 and the required display piece 74 removed from the storage tray 98 by simply pressing downwardly thereon. Once separated from the remainder of the base portion 100 of the storage tray 98, the display piece 74 of interest is set aside while the storage tray 98 is returned to its stowed position. Thereafter, the display tray 24 is removed from the frame assembly 14 by first releasing the catch 94 and removing the display tray 24 through the first tray receiving slot 76.

At this time, the cover material 114 is manually removed from the display piece 74 of interest, thereby exposing the adhesive layer 112. After locating the outline map 18 depicting the state corresponding to the display piece 74 of interest, the display piece 74 is manually rotated and aligned closely over the display surface 22 of the display tray 24 to precisely register with the outline map 18 and the display piece 74 is pressed into position. The process is completed by returning the display tray 24 to its stowed position and re-engaging the catch 94.

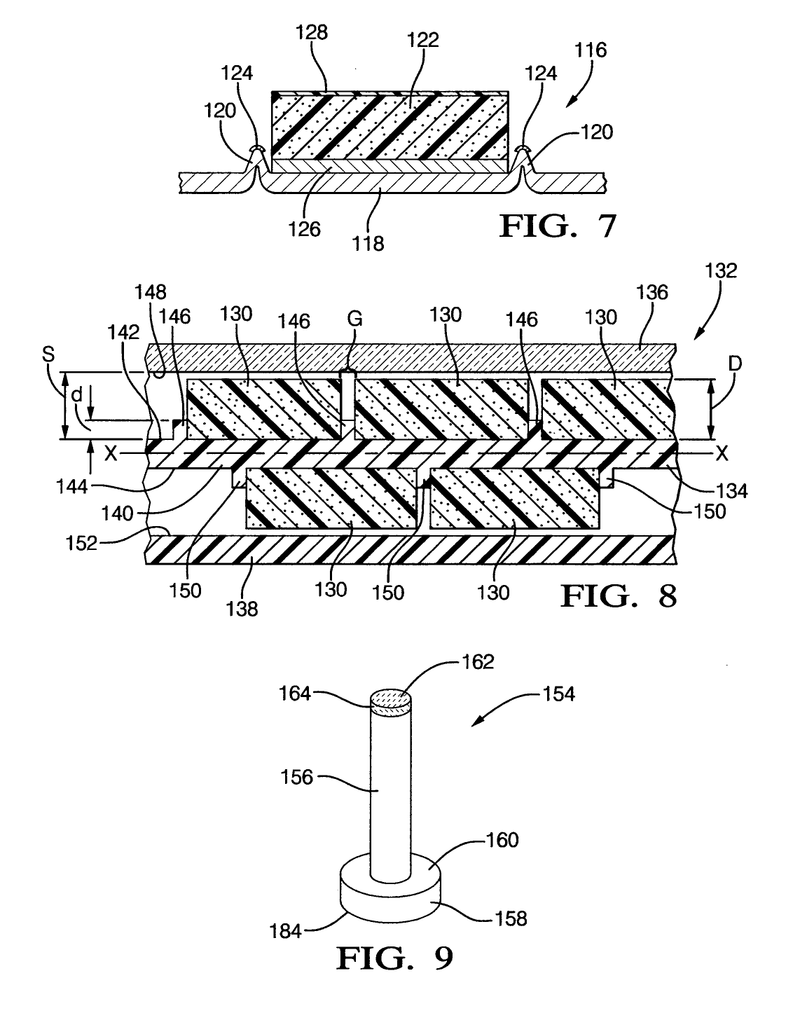

As an alternative to the adhesively affixing the display pieces 74 to the display tray 24, it may be desirable to employ permanent magnets and ferrous materials to magnetically affix the display pieces 74 to the display tray. Referring to FIG. 7, an alternative embodiment of a travel recording apparatus 116 is illustrated. A broken portion of a display tray 118 has elongated raised portions 120 formed therein configured to nestingly receive associated display pieces 122. The raised portions 120 substantially conform to the outline map 18 depicted in FIG. 1. Preferably, the crests of raised portions 120 have trace lines 124 formed thereon. Trace lines 124 would preferably be of a bright or contrasting color, both as an aid to the user and for aesthetic purposes. A thin section permanent magnet 126 is affixed to the bottom surface of each display piece 122. Display tray 118 is formed of ferrous material such as mild steel, which has been decoratively painted. The top surface of the display piece 122 is covered with a decorative, protective lamination layer 128.

The system of raised portions 120 described herein preferably corresponds precisely with the outline map 18 depiction the geographic region treated by the travel recording apparatus 116. The raised portions 120 ensure precise alignment and orientation of each display piece 122 and provides a small degree of spacing between adjacent display pieces 122 to allow viewing of the trace lines 124 there between. This feature is believed to substantially enhance the overall esthetic appearance of the travel recording apparatus 116 by presenting the viewer with a colorful uniform mosaic. In addition, the raised portions 120 protect against unintended lateral displacement of the display pieces 122 due to vibration or rough handling. Any vibration induced displacement of a given display piece 122 will actually tend to self-center the display piece 122 in its design intent placement due to the impinging slopes of the abutting raised portions 120.

Referring to FIG. 8, a third approach to affixation of display pieces 130 within a travel recording apparatus 132 is illustrated in which a system of precisely spaced abutment surfaces interact to mechanically interlock each display piece 130 into either its design intent storage position or its design intent display position.

In FIG. 8, a broken portion of a conjoined display-storage tray 134 is sandwiched between a transparent closure member 136 and a back or bottom member 138. Closure member 136 and back member 138 are mutually parallel and are affixed in their illustrated spaced relation by a circumferentially encompassing frame assembly (not illustrated) similar to that described with regard to the embodiment of the invention of FIGS. 1-5. Likewise, display-storage tray 134 is disposed parallel to and intermediate closure member 136 and back member 138 in a slip fit relationship with the frame assembly, whereby the display-storage tray 134 is selectively displaceable from an enclosed stowed (illustrated) position to an open position for user access to the display pieces 130 by relative movement along axis X-X in drawer-like fashion.

By “conjoined” the applicant means a tray 134 comprising planar, generally rectangular base portion 140 having an upwardly facing display surface 142 and a downwardly facing storage surface 144. Thus, when the tray 134 is removed from the frame assembly of the travel recording apparatus 132, all display pieces 130 (i.e. those carried on the display surface 142 and those carried on the storage surface 144) are removed therewith.

A series of display piece positioning and engaging extensions 146 are integrally formed with base portion 140 of tray 134 and extend normally upwardly from display surface 130. Extensions 146 are arranged to circumferentially embrace the edges of each display piece 130 to define the design intent location of each display piece 130 on the display surface 142. Base portion 140 and extensions 146 of tray 134 are formed of injection molded plastic or other suitable material.

Dimensionally, the lower surface 148 of closure member 136 is spaced from the display surface 142 of tray 134 by a dimension designated “S” and extensions stand off upwardly from display surface a dimension designated “d”. The nominal thickness of each display piece 130 is designated “D”. In the preferred arrangement illustrated in FIG. 8, S is slightly greater than D and d+D is greater than S. Extensions 146 are precisely positioned to establish a precise slip-fit with their associated display pieces 130 to affect a nesting relationship there between. As illustrated, the individual display pieces 130 disposed on the display surface 142 are thus interlocked thereon by the cooperation of the lower surface 148 of the closure member 136, the display surface 142 of the display-storage tray 134 and the abutting side surfaces of the extensions 146.

Similarly, a set of downwardly directed extensions 150 are formed on the storage surface 144 of tray 134. The upper surface 152 of the back member 138, the storage surface 144 of the display-storage tray 134 and the abutting sides of the extensions 150 cooperate to mechanically interlock any “stored” display pieces 130 disposed on the storage surface 144 in the same manner as described herein above relating to the display pieces 130 disposed on the display surface 142 of the tray 134.

The width of extensions 146 is preferably constant to produce an aesthetically pleasing uniform spacing or gap, designated “G” between display pieces 130 disposed on display surface 142.

Referring to FIG. 9, a marker pin 154 is illustrated. Marker pin 154 comprises an elongated shank portion of circular cross-section with an enlarged diameter head portion 158 affixed at one end thereof. The point of transition between the shank portion 156 and head portion 158 defines a radially directed flange 160. The end of shank portion 156 opposite the head portion 158 terminates in a circular marker surface 162 having a brightly colored coating 164, preferably of fluorescent yellow, to enhance visibility.

Marker pin 154 is constructed of rigid material such as stainless steel with color coating 164 formed of high pigment, highly reflective glossy paint. Alternatively, marker pin can be constructed of transparent material such as fiber optic plastic cable with a connection to either an ambient or artificial light source connected thereto (not illustrated). An inventory of marker pins 154 would be supplied with a travel recording apparatus 10 and could be stored within storage holes (not illustrated) formed on the storage tray 98 for easy access.

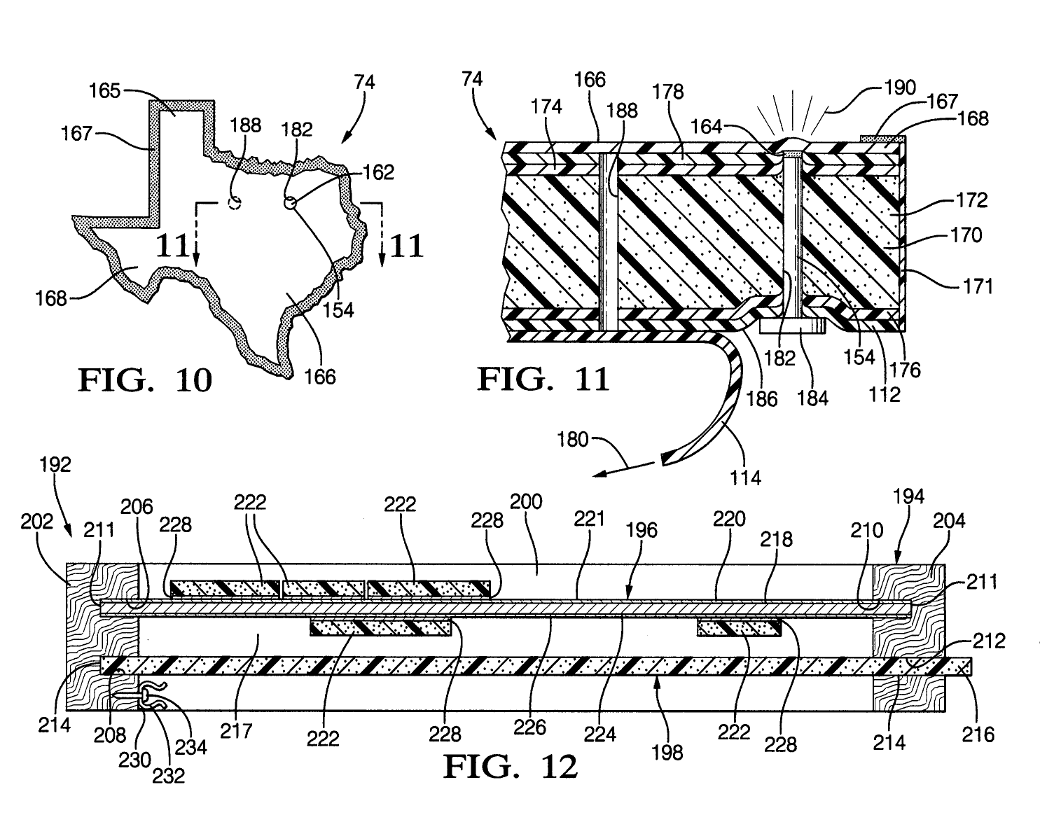

Referring to FIG. 10, the front or display side 166 of a typical display piece 74, as described in connection with the embodiment of the invention of FIGS. 1-6, (depicting the state of Texas) is illustrated. In the preferred embodiment, no political or topographical features are located on display side 166, which would be of one uniform prominent color 165. Optionally, a peripheral border 167 of a contrasting color would improve the aesthetic appearance. A marker pin 154 is applied to signify a location corresponding to the city of Dallas.

Referring to FIG. 11, display piece 74 comprises a decorative upper layer 168, which, in application, would be positioned to face the viewer 70 (refer FIG. 3). Decorative upper layer 168 overlays a substrate 170. Decorative upper layer 168 is constructed of lightly tinted or smoked translucent plastic film, such as Mylar. Substrate 170 comprises sheet foam board consisting of a core 172 of low density material such as Styrofoam adhesively laminated between upper and lower layers of high quality paper or cardboard 174 and 176, respectively. Decorative upper layer 168 is bonded to upper layer 174 of substrate 170 by a resilient adhesive layer 178. A removable layer of sheet cover material 114 is removably affixed to an adhesive layer 112, which, in turn, is bonded to lower paper layer 176 of substrate 170. Adhesive layer 112 is formed of a material having an affinity for both the lower paper layer 176 of substrate 170 as well as the material forming the display surface 22 of the display tray 24 (see FIG. 3), but be easily releasable from cover material 114. The peripheral edge 171 of each display piece 74 can be of a contrasting color similar to border color 167, a main color 165 or a different, secondary/tertiary contrasting or complimentary color.

As described herein above, when a particular display piece 74 is designated for installation on the display surface 22 of the display tray 24, the associated cover material 114 is first removed as illustrated by arrow 180. If a marker pin 154 is to be installed, the user first estimates the exact location on the display piece 74 to be highlighted corresponding with a location of a memorable travel event during a visitation to that state. The marker pin 154 is then pushed through the substrate 170 from the back side, fully penetrating adhesive layer 112, lower paper layer 176, core 172, upper paper layer 174 and resilient adhesive layer 178, forming a passageway 182 there through. The marker pin 154 is fully inserted when the flange 160 of head portion 158 abuts against adhesive layer 112 and thereby slightly locally compresses the foam material within core 172, whereby the marker surface 162 at the opposite end of the marker pin 154 abuts or slightly distends, but does not penetrate, the decorative upper layer 168. When the marker pin 154 is properly installed, the bottom surface 184 of the head portion 158 is substantially flush with the bottom surface 186 of the exposed adhesive layer 112.

Once the marker pin 154 is properly installed, the display piece 74 is placed at its design location on the display surface 22 of the display tray 24. Once so assembled, the marker pin 154 is firmly held in position between the display tray 24 and the associated display piece 74.

The advantage of this aspect of the invention is that the brightly colored marker surface 162 is clearly visible from the perspective of the viewer 70 (see FIG. 3) as illustrated by rays 190, but it has not created a visible hole in the display piece 74 should the marker pin ever be removed. This is because the contrasting bright colored marker surface 162 can be seen through the tinted decorative upper layer 168, but, once removed, the remaining darkened void 188 does not contrast with the tinted decorative upper layer 168 and is largely invisible to the viewer 70. furthermore, no tell-tale hole has been created in the decorative upper layer of the display piece 74, which will always retain its original appearance.

### Preferred Embodiment of the Invention

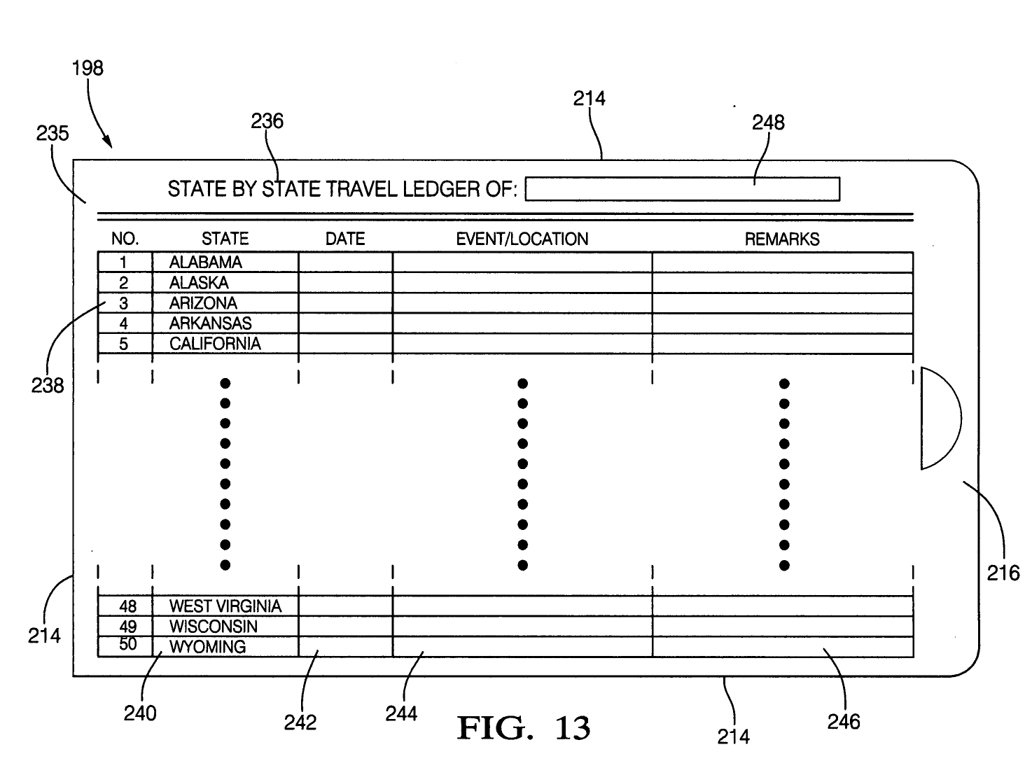

Referring to FIG. 12, the presently preferred embodiment of a travel recording apparatus 192 is illustrated. This particular embodiment of the invention is preferred inasmuch as it is simpler to produce and use, and is of lower cost. Furthermore, this embodiment has additional features and can be used for other purposes.

While the previously described embodiments of the invention are primarily intended for relatively passive formal display purposes, the preferred embodiment of the travel recording apparatus 192 can also be used as a toy or diversion (such as while traveling) or as an educational aid.

It is contemplated that the preferred embodiment of the invention will be well received as a convenient way to record personal or family travel related data. Once on display at home or in an RV, it can serve as the centerpiece for contemplating fond memories or relating travel experiences to friends, fellow travelers and the like.

Travel recording apparatus 192 comprises a frame assembly 194, a conjoined display-storage panel 196 and a travel ledger board 198. Frame assembly 194 is composed of upper and lower elongated frame members 200 (lower frame member is not illustrated) and left and right side elongated frame members 202 and 204, respectively, arranged and joined at the respective ends thereof in a generally rectangular configuration. Upper, lower and left side frame members 200, no number and 202, respectively, have a substantially common cross-sectional area along their respective lines of elongation. Upper, lower and left side frame members 200, no number and 208, respectively, have a generally “E” shaped section, defining spaced upper and lower inwardly directed grooves 206 and 208 formed therein. Frame assembly 194 is preferably formed of wood, but could alternatively be constructed of plastic, metal or other suitable material capable of having a decorative finish and supporting the overall structure of the travel recording apparatus 192.

Right side frame member 204 forms an inwardly opening groove 210 aligned on a common plane with grooves 206 in the other frame members. When assembled, frame assembly 194 entraps display-storage panel 196 about the peripheral edges 211 thereof within grooves 206 and 210. Accordingly, panel 196 is permanently confined within frame assembly 194. Panel 196 is formed of ferrous material such as mild steel and is configured in a generally rectangular planar configuration. Panel 196 is of a thick enough gauge material to easily support its own weight as well as the weight and stresses of intended use and play activity there upon.

Right side frame member 204 also forms an elongated travel ledger board receiving slot 212 extending there through. The slot 212 is aligned on a common plane with lower grooves 208 of the other members of frame assembly 194. Travel ledger board 198 is preferably formed of lightweight rigid sheet material such as foam board and is shaped in a generally rectangular configuration to form a precise slip-fit through slot 212 and grooves 208. When in the stowed position as illustrated in FIG. 12, the travel ledger board is supported substantially about the peripheral edges 214 thereof by the grooves 208 and slot 212. Although only one travel ledger board 198 is illustrated in FIG. 12, it is contemplated that two or more ledgers 198 could be provided, either stacked and stowed within slot 212 and grooves 208 or, alternatively, each sheet disposed in a separate groove and slot system.

While in the stowed position, the travel ledger board 198 extends slightly outwardly of frame assembly 194 to form a pull 216, providing a gripping surface to enable easy removal and replacement of the travel ledger board 198 within the frame assembly 194. Removal and replacement of the board 198 is similar to manipulation of the display and storage trays 24 and 98, respectively, as described in connection with the embodiment of FIGS. 1-6. A latch (not illustrated) can be provided to selectively retain travel ledger board within its stowed position.

Frame assembly 194, display-storage panel 196 and travel ledger board 198 cooperate to form a closed compartment 217, which is accessible only by slidingly displacing the travel ledger board 198 from the illustrated closed or stowed position to an open position. Compartment 217 is convenient for storage of display pieces 222 as well as supplemental articles such as location marker pins and stickers for the front surface of the display pieces, note pads, maps, calculators, event calendars, writing implements and the like.

For additional convenience, a writing implement such as a fine point marker (not illustrated) can be removably affixed to an unobtrusive or hidden external surface 230 of frame assembly 194 by means such as a spring clip 232 affixed to a frame member 202 by a fastener such as a nail 234. This provides the convenience of rapid access to a writing implement and a pre-formatted log in response to an unexpected event while traveling.

As in the case of the alternative embodiment of the invention described herein above, the upper (exposed) display surface 218 of display-storage panel 196 has a display object 220 imprinted thereon in the form of an outline map depicting a predetermined, substantially contiguous geographic region and environs, substantially as illustrated and described in connection with FIG. 1. The outline map is properly scaled to define precise design intent locators, preferably in the form of a collage of juxtaposed separate outline maps for each geographic area or state, for each of the fifty display pieces 222. Display object 220 is preferably formed by painting and/or silkscreen printing processes directly upon upper surface 218. Alternatively, display object 220 can be formed separately, such as by imprinting upon a separate sheet of paper, cardboard, plastic or the like and disposed to overlay upper surface 218.

Likewise, the bottom storage surface 224 of the display-storage panel 196 has locators such as scaled individual outline maps 226 corresponding with each of the fifty display pieces 222 similar to the peripheral outlines 108 described in connection with FIG. 6.

As in the case of the embodiment of the invention described in connection with FIGS. 1-6, each of the fifty display pieces 222 are shaped to mimic the particular state they represent and are scaled and dimensioned to precisely overlay their respective outline maps imprinted upon display surface 220 and storage surface 226 of display-storage panel 196.

As in the case of the display pieces 122 described in connection with FIG. 7, display pieces 222 are formed of wood or other robust material that can be easily painted and hold up to extensive use. Each piece has a low profile permanent magnet 228 adhesively affixed to the bottom surface thereof for selective magnetic attachment to either the display surface 220 or storage surface 226 of the panel 196. In the preferred embodiment of the invention, the individual display pieces 222 can be placed in direct tangential abutting juxtaposition to one another.

One significant difference of the preferred embodiment of the invention, contrasted with the alternative embodiment described in connection with FIGS. 1-6, is the preferred embodiment lacks a transparent front closure member. This allows direct and immediate access to display pieces 222 at any time without first having to open compartment 217. This feature maximizes convenience and overall utility of the travel recording apparatus 192 when it is being employed for play or teaching. Of course, access to display pieces 222 stored within closed compartment 217 requires momentary movement of the travel ledger board.

Referring to FIG. 13, an example of the composition and layout of the travel ledger board 198 is illustrated. FIG. 13 depicts an example obverse or data entry side 235 of travel ledger board 198. Imprinted upon the data entry side 235 of the travel ledger board 198 is subject matter or other informational text 236, as well as data fields arrayed in ranks and columns. Certain data fields are pre-filled with information, such a numerical ordering 238 and alphabetically ordered geographic area or state identification 240. Other, unpopulated data fields are provided to record visitation date 242, specific event attended or location of visit 244 and generalized remarks 246 such as names of acquaintances, weather conditions, telephone/contact information, expenses and the like. Other “one-of” unpopulated data fields, such as the generalized topic or principle record keeper 248 are also provided.

The information imprinted upon the travel ledger board 198 can be directly disposed, for example, of the outer paper covering of the foam board structure. Alternatively, the information can be imprinted upon removable/replaceable sheets, which would be convenient if an error required correction or if the travel recording apparatus 192 was to be used for two or more separate and discrete usages.

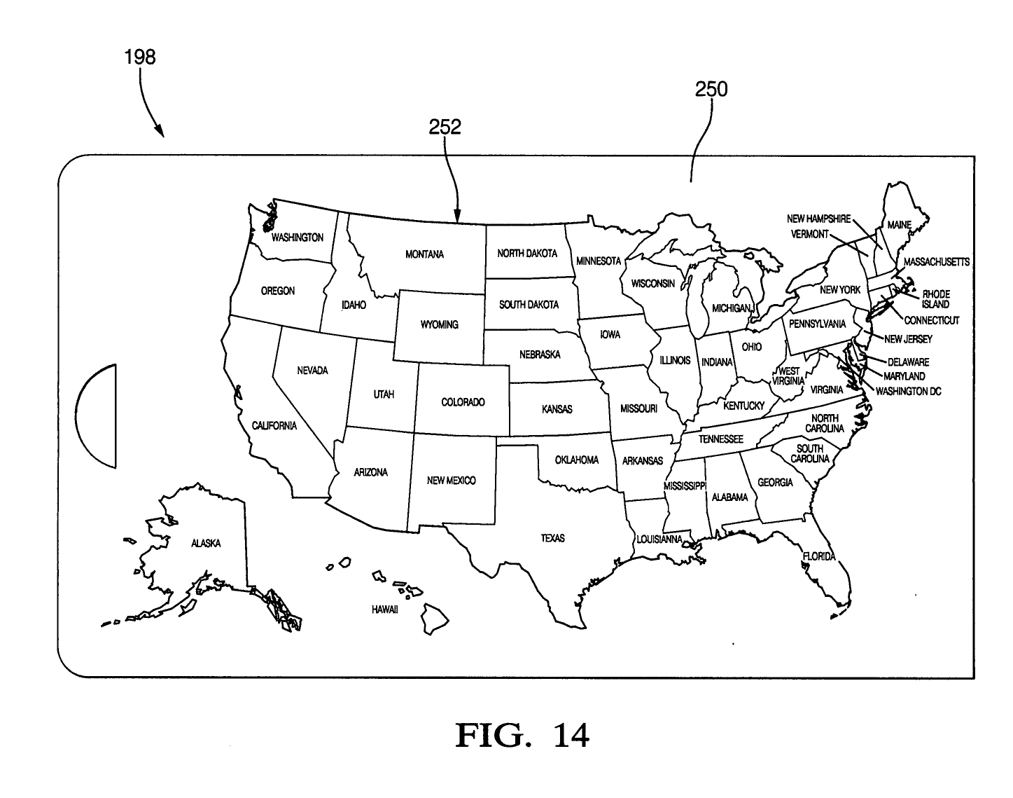

Referring to FIG. 14, the reverse or tutorial side 250 of the travel ledger board 198 can be imprinted with reference information such as a reduced scale map 252 depicting the geographic area, region and environs by name, as an instructional guide.

It is to be understood that the invention has been described with reference to specific embodiments and variations to provide the features and advantages previously described and that the embodiments are susceptible of modification as will be apparent to those skilled in the art.

Furthermore, it is contemplated that many alternative, common inexpensive materials can be employed to construct the basic constituent components. Accordingly, the forgoing is not to be construed in a limiting sense.

The invention has been described in an illustrative manner, and it is to be understood that the terminology, which has been used is intended to be in the nature of words of description rather than of limitation.

Obviously, many modifications and variations of the present invention are possible in light of the above teachings. For example, the applicant believes that a display piece depicting a single state as the geographic region and the various counties within said state as the geographic areas would also be of particular regional interest. It is, therefore, to be understood that within the scope of the appended claims, wherein reference numerals are merely for illustrative purposes and convenience and are not to be in any way limiting, the invention, which is defined by the following claims as interpreted according to the principles of patent law, including the Doctrine of Equivalents, may be practiced otherwise than as specifically described.

1. A travel recording apparatus comprising:
a set of display pieces, each piece configured to depict a specific geographic area and, when arranged in a predetermined orientation, collectively configured to depict a larger geographic region;
a display tray defining a generally planar display surface dimensioned to circumscribe said set of pieces when disposed in said predetermined orientation on said display surface;
a storage tray defining at least one storage surface dimensioned to circumscribe said set of pieces when disposed on said storage surface;
frame means operative to retain said display and storage trays in spaced juxtaposition wherein said display surface and any pieces disposed thereon are outwardly visible, and said storage surface and any pieces disposed thereon are substantially obscured from view; and
retention means operative to selectively affix at least some of said pieces at corresponding predetermined locations on said display surface and, alternatively, on said storage surface.

2. The travel recording apparatus of claim 1, wherein said display pieces are selectively magnetically affixed to said display tray.

3. The travel recording apparatus of claim 1, wherein said display pieces are selectively adhesively affixed to said display tray.

4. The travel recording apparatus of claim 1, wherein said display pieces are substantially mechanically interlocked in predetermined juxtaposition with the display tray and frame means.

5. A travel recording apparatus comprising:
a set of display pieces, each piece peripherally configured to depict a scaled specific geographic area and, when arranged in a predetermined orientation, collectively configured to depict a larger, substantially contiguous geographic region;
a display tray defining a generally planar display surface and a peripheral edge dimensioned to circumscribe said set of pieces when disposed in said predetermined orientation on said display surface;
a storage tray defining a generally planar storage surface and a peripheral edge dimensioned to circumscribe said set of pieces when disposed on said storage surface;
a mounting frame dimensioned to substantially enclose and removably retain at least one of said display and storage trays in spaced, generally parallel juxtaposition wherein said display surface and any pieces disposed thereon are outwardly visible and said storage tray and any pieces disposed on said storage surface are substantially obscured from view; and
retention means operative to selectively removably affix each individual piece at a predetermined location and orientation on said display surface and, alternatively, on said storage surface.

6. The travel recording apparatus of claim 5, further comprising a scaled outline map of each display piece disposed on said display tray surface, said display piece specific maps arranged to form an aggregate map of said geographic region, whereby each display piece has a corresponding outline map on said display tray surface with a substantially 1:1 scale therewith.

7. The travel recording apparatus of claim 6, wherein each said outline map comprises an upraised continuous ridge, which peripherally engages its respective display piece.

8. The travel recording apparatus of claim 5, wherein said mounting frame further comprises a closure member constructed of substantially transparent material positioned to register with and overlay said display tray.

9. The travel recording apparatus of claim 5, wherein said display tray and storage tray are substantially interchangeable.

10. The travel recording apparatus of claim 5, wherein said frame means further comprises means operative to selectively affix said travel recording apparatus upon a generally vertical viewing surface.

11. The travel recording apparatus of claim 5, further comprising theme-based indicia disposed upon an externally visible surface of said apparatus.

12. The travel recording apparatus of claim 5, wherein said display pieces and storage tray are co-formed from at least one piece of source material.

13. The travel recording apparatus of claim 12, wherein the peripheral edge of at least one display piece is pre-formed in said sheet of source material.

14. The travel recording apparatus of claim 12, wherein said sheet of source material defines a pull feature therein in a portion thereof accessible to a user externally of said mounting frame.

15. The travel recording apparatus of claim 5, wherein said display and storage trays are conjoined with said display surface disposed for facing outwardly and said storage surface disposed for facing inwardly.

16. The travel recording apparatus of claim 5, further comprising an alpha-numeric based descriptor for one or more of said display pieces, each descriptor disposed on said storage surface near an intended storage location of an associated display piece on said storage surface.

17. The travel recording apparatus of claim 16, further comprising a peripheral outline of an associated display piece disposed on said storage surface adjacent said descriptor.

18. The travel recording apparatus of claim 5, further comprising a travel event recording ledger carried therewith and defining at least one data entry field corresponding to each specific geographic area.

19. The travel recording apparatus of claim 5, wherein said display pieces are formed of generally planer material having a nominal thickness dimension, each display piece comprising a display surface and an opposed base surface.

20. The travel recording apparatus of claim 19, wherein said display pieces further comprise a permanent magnet affixed to said base surface, and wherein at least said display tray surface is formed of ferrous material.

21. The travel recording apparatus of claim 19, wherein said display pieces further comprise an adhesive layer affixed to said base surface, and formed of a material having an adhesive affinity for at least the material forming said display tray surface.

22. The travel recording apparatus of claim 19, further comprising marker means configured for selective affixation to a display piece to designate a predetermined geographic or political feature depicted thereby.

23. The travel recording apparatus of claim 22, wherein said marker means comprises an elongated pin configured for selective insertion within a display piece, wherein a viewing surface of said pin is disposed adjacent the associated piece display surface and is formed in a contrasting color therewith.

24. The travel recording apparatus of claim 23, wherein said marker means further comprises an enlarged head portion disposed adjacent the associated piece base surface to limit displacement of said elongated pin there through.

25. The travel recording apparatus of claim 23, wherein said piece display surface is formed by a thin, translucent member, such as Mylar.

26. The travel recording apparatus of claim 19, wherein said display surface has geographical, historical or political points of interest depicted thereon.

27. The travel recording apparatus of claim 5, further comprising a system of abutment surfaces operative to mechanically interlock each said display piece in its predetermined orientation on said display tray.

28. A theme-based travel recording apparatus comprising:
a set of display pieces formed of generally planar material having a colored display surface, an opposed base surface and edge surfaces extending normally there between, each piece configured to depict a specific predetermined geographic area and, when arranged in a predetermined orientation, collectively configured to depict a larger, substantially contiguous predetermined geographic region;
a display tray defining a generally planar display surface dimensioned to encompass said set of pieces when disposed with their base surfaces on said display surface in said predetermined orientation;
a storage tray defining a generally planar storage surface dimensioned to encompass said set of pieces when disposed with their base surfaces on said storage surface;
a mounting frame dimensioned to substantially enclose and removably retain said display and storage trays in spaced, generally parallel juxtaposition under a generally planar viewing window, wherein said display surface and any display pieces disposed on the display surface are outwardly viewable through said window and said storage tray and any display pieces disposed on the storage surface are substantially obscured from view through said window;
retention means operative to selectively removably affix each individual piece at a predetermined location and orientation on said display surface and, alternatively, on said storage surface;
means operative to selectively affix said mounting frame to a generally vertical viewing surface;
theme-based indicia disposed upon an externally visible surface of said apparatus;
an alpha-numeric based descriptor for one or more of said display pieces, each descriptor disposed on said storage surface near an intended location of an associated display piece on said storage surface;
a peripheral outline of an associated display piece disposed on said storage surface adjacent said descriptor;
marker means removably carried by said storage tray, said marker means configured for selective affixation on the display surface of a display piece to designate a predetermined geographic or political feature; and
a travel event ledger carried with and selectively removable from said apparatus, said travel event ledger containing predetermined information fields, wherein some of said information fields are pre-populated with data.
